(19) United States
(12) Patent Application Publication
(10) Pub. No.: US 2003/0046093 A1
(43) Pub. Date: Mar. 6, 2003

(54) Rights management

(76) Inventors: John S. Erickson, Norwich, VT (US); Matthew Murray Williamson, Bristol (DE)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 09/941,568

(22) Filed: Aug. 30, 2001

(51) Int. Cl. G06F 17/60

(52) U.S. Cl. 705/1; 705/51

(57) ABSTRACT

Apparatus for determining the output of a contract or agreement at any point in time as required, comprising means for creating a state machine representative of the contract or agreement, at least some of the clauses and/or conditions of the contract or agreement being represented as a respective state variable of the state machine, means for storing the state machine, means for receiving data representative of one or more events relevant to the contract or agreement, determining whether the event changes the state of the state machine and changing the state of the state machine if required. The apparatus of the present invention, can provide the core for licence repository and automated rights management services, making the task of rights decision-making easier and more efficient. A preferred embodiment involves providing an novel digital representation of the contract, the unique aspect of this model being that it is dynamic, in that it accurately captures the sequential characteristics of real contracts. In other words, the present invention provides means for explicitly capturing the full sequential, conditional flow of a contract, including specific outputs (rights and obligations) for states within the contract.

### FIELD OF THE INVENTION

This invention relates to rights management and, in particular to a system for electronic management of rights contracts and/or licenses, particularly but not exclusively relating to copyright and similar rights.

### BACKGROUND TO THE INVENTION

Copyright is an intellectual property right which gives rights to the creators of certain kinds of material, so that they can control the various ways in which their material may be exploited. It is intended to protect original literary, dramatic, musical and artistic works, published editions of works, sound recordings, films (including videograms) and broadcasts (including cable and satellite broadcasts), and the rights afforded by copyright broadly cover copying, adapting, issuing copies to the public, performing in public and broadcasting such protected material. In many cases, the author will also have the right to be identified on his work and object to distortions and mutilations of his work. Further, a rental right is given to owners of copyright in sound recordings, films and computer programs and therefore the exploitation of such works by renting them to the public requires a licence from the copyright owner.

In general, copyright exists automatically once a work protectable by copyright has been created. Most Western European countries, the USA and the USSR belong to at least one international copyright convention, whereby protection provided by copyright which exists in one of the member countries extends to all of the countries who are members of that international convention. Subject to a few limited exceptions, a third party would require permission from the owner of any copyright in a work in order to copy or publicly exploit the work. Such permission may be obtained by approaching the copyright owner directly, and obtaining a contract or licence setting out the terms and conditions under which such copying or exploitation may take place. However, there are several organisations which act collectively for groups of copyright owners in respect of particular rights, and such organisations may offer ‘blanket’ licences to users.

In the publishing and media industries, rights contracts or licences provide key reference points for authors, publishers and intermediaries, and must be consulted whenever a rights transaction is being made, or when previously acquired or licensed copyright material is to be published or exploited in new ways.

Typically, such contracts or licences have been captured on paper, stored in a physical storage medium, such as a filing cabinet, and manually retrieved and reviewed. In general, manual evaluation of such contracts can be tedious and is prone to error because, in general, this type of contract contains numerous clauses expressing promises and obligations between the parties to the contract, such clauses providing for a variety of different situations which, in turn, tend to be dependent upon the condition that other promises and obligations have been fulfilled or satisfied. Such dependencies are often expressed using terms such as ‘conditions precedent’ or ‘conditions subsequent’. In order to interpret the ‘output’ or ‘state’ of a contract for a given set of circumstances, it is also necessary to take into account the role of a party or individual relative to the contract, and/or the identity of the intellectual property forming the basis of the contract, as well as the time and date at which such interpretation takes place.

Thus, in the case of, for example, complex publishing contracts and the like, which tend to specify different outcomes according to a variety of circumstances, it can be difficult to manually evaluate the state of the contract accurately at any given point in time and under a specific set of circumstances (which usually includes the contract's performance history), and as a result, ‘authorisation queries’ against a contract which may seem quite straightforward, such as the rights and obligations in force for a particular querying party at any given instant, are potentially quite difficult evaluate accurately. In the rapidly growing information commerce market in particular, which is founded upon the trading of various ‘use rights’ to information products, this can cause a number of problems.

It can be seen that stakeholders throughout the publishing and media industries in particular would benefit if their rights contracts or licences are in an electronic, actionable form, and a range of different solutions have been proposed in the prior art, which range from representing digital contracts as flat data structures to constructing special-purpose, dynamic executable objects, and some of such prior art solutions will be described in more detail below.

Thus, one potential solution comprises the steps of optically scanning contracts and storing the resulting images in a digital repository. However, this approach is of limited utility because it only provides the user with images or reprints of the contracts, i.e. the evaluation process is identical to the process described above in relation to paper copies of the contracts. Thus, this solution does not significantly enhance the decision-making process and provides no basis for automation.

A similar solution once again comprises the step of optically scanning contracts and applying optical character recognition (OCR) so as to create fully electronic records of the contracts. This solution has the advantage that contracts in the repository are fully text-searchable. However, the electronic contracts are not ‘smart’ and, as such, this solution provides no basis for automation. A slight variation in the OCR approach described above employs ‘document understanding’ technology to create a structured document or record based upon a specific template. Electronic contracts represented in this fashion are more useful than ‘flat’ electronic versions, particularly for applications, such as word processors or document viewers that may use structural information to guide editing, presentation and/or validation. However, because there is no explicit representation of the dynamic logic of the contract, this approach provides only a limited basis for automated evaluation.

U.S. Pat. No. 5,991,876 describes an electronic rights management and authorisation system to account for the dynamic, multi-dimensional and granular nature of rights. A database structure divides works and rights into two related tables. A works table includes information sufficient to identify works managed by the system, while a rights table identifies a right associated with a work and includes one or more date fields delimiting the right. The rights table may also include type of use information. Additional tables, such as a work relation table, a party table or an order table may be provided. Software is used to manage and query the database structure.

International Patent Application No. WO 00/42555A1 describes a method and system for registering and licensing works over a network, which generally provides for registering works of authorship in an online database and for providing licensing information about authorship with several rights agencies, royalty collecting societies and copyright offices, and the online database in a single process. The arrangement allows individuals to identify a particular work of authorship from among many close variants, analyse the licensing rights necessary for a particular use of the work by an individual in a particular territory, determine the source of the licensing rights in that territory, and forward a request for a licence to that source. The arrangement may also include means for issuing a licence to an individual for the contemplated use of a work.

However, the copyright database and transaction systems described in both U.S. Pat. No. 5,991,876 and WO 00/42555A1 are based upon static representations of rights contracts. The rights records stored in these systems accurately reflect the state of contracts at particular moments in time, under particular circumstances (such as the act of transacting copyright permissions), but these systems are not capable of reflecting the rich dynamic character of a real publishing contract. Therefore, such systems have limited application.

Yet another potential solution, proposed by R. Martin Roscheisen and published in paper entitled “A Network-Centric Design for Relationship-Based Rights Management” (Stanford University, 1997), provides an executable contract model based upon object-orientated software technologies. In this solution, key aspects of contracts, such as parties, items and promises (particularly rights and obligations) are represented as executable objects, and as such this approach provides a very limited basis for automated contract evaluation. However, it does not allow for explicitly and unambiguously capturing the complex sequential relationships and contingencies that may exist between the terms of a contract. Furthermore, it does not provide any way to explicitly express the dependency of clauses within one contract upon the internal state of other contracts.

We have now devised an arrangement which overcomes the problems outlined above, and provides a means for explicitly capturing the full sequential, conditional flow of the contract, including specific outputs (rights and obligations) for states within the contract.

### SUMMARY OF THE INVENTION

Thus, in accordance with a first aspect of the present invention, there is provided apparatus for determining the output of a contract or agreement at any point in time as required, comprising means for creating a state machine representative of said contract or agreement, at least some of the clauses and/or conditions of said contract or agreement being represented as a respective state variable of said state machine, means for storing said state machine, means for receiving data representative of one or more events relevant to said contract or agreement, determining whether said event changes the state of said state machine and changing the state of said state machine if required.

The first aspect of the present invention also extends to a method of determining the output of a contract or agreement at any point in time as required, the method comprising the steps of creating a state machine representative of said contract or agreement, at least some of the clauses and/or conditions of said contract or agreement being represented by a respective state variable of said state machine, storing said state machine, receiving data representative of one or more events relevant to said contract or agreement, determining whether said event results in a change of state of said state machine and changing the state of said state machine accordingly, determining the state of said state machine at a point in time as required, and determining the output of said contract or agreement accordingly.

The apparatus preferably comprises means for storing a plurality of state machines, each representative of a respective contract or agreement, the output of each said contract or agreement being determinable concurrently, as required.

In accordance with a second aspect of the present invention, there is provided apparatus for storing electronically a plurality of contracts or agreements each having a plurality of possible outputs dependent upon the occurrence (or otherwise) of one or more events, means for receiving information relating to one or more events relevant to one or more of said contracts or agreements and means for determining the output of one or more of said contracts in response to the occurrence (or otherwise) of said one or more events.

In a preferred embodiment, said contracts or agreements are stored in the form of respective state machines, each of which is representative of one of said contracts or agreements, the output of one or more of the contracts or agreements being determinable from the state of the respective state machine(s).

The apparatus of the present invention is preferably realised using a structured, declarative computer language for expressing contracts, said computer language being capable of expressing the behaviour of the ‘virtual contracts’ or state machines. An important aspect of such a language is that it preferably contains syntax for expressing the sequential, state machine behaviour or ‘rules’ typical of contracts. The dynamic state machine behaviour (especially the state transitions within the contract model) is thus expressed in terms of the logical combination of events and conditions that may be in effect within a given state of the contract state machine.

A preferred contract state machine computer language also includes syntax for specifying the “output” of a contract or agreement in any given state, based upon the conditions that may be in effect in any given state of the contract state machine. The computer language used to realise the present invention is preferably an object-orientated computer language, in which case, the outputs of a contract state machine object are assertions that the object makes to other objects or systems. Specific examples of outputs might include (but are not limited to) variables or “flags” that indicate the state of a particular right, or action that must be taken regarding a payment (for example, “pay XXX to YYY now”).

A unique aspect of the present invention is the ability of virtual contract instances to be executed separately and independently from the software components that execute the actions specified by the outputs. In a preferred embodiment of the present invention, the virtual contracts are responsible for determining that certain “rights” or “obligations” are true, but not for interpreting what those assertions actually mean. In a preferred embodiment, the apparatus includes software components or systems which receive the output assertions of the virtual contracts or objects, and determine and implement the “wishes” or “intentions” of the contracts, as required.

A preferred embodiment of the present invention, comprises a kernel comprising means for storing a plurality of contracts or agreements in the form of state machines, means for receiving information regarding events relevant to one or more of the contracts or agreements, and means for changing the state of one or more of the state machines as required according to said event. Thus, the kernel of this preferred embodiment of the invention can provide the basis for a generalised policy enforcement system, ranging from rights management to privacy enforcement to automated business negotiations, the means for determining the actual meaning of the state of a contract or agreement at any one time being designed separately and according to specific requirements.

The heart of the virtual contract manager referred to above, is the provision of a generalised event queue which accommodates “external” and “internal” events. Examples of external events might include queries or assertions from outside the system, such as queries for authorisation for access, or affirmations from payment services that payments have been made. Examples of “internal” events might include the arrival of declared moments in time, either absolute or relative (e.g. a particular length of time from the start of the contract or from entering a state within the contract). Of course, in many cases, the occurrence of external or internal events will trigger communications requests to parties of the contract, requiring their intervention in order to qualify a pending state or to take some action to effect transition to a further state.

If the state of a contract or agreement has not changed for a predetermined period of time, the contract is preferably persisted to (preferably) local storage means to await the occurrence of one or more events which affect its behaviour or output.

In a preferred embodiment of the present invention, upon initialisation, virtual contract objects are “registered” with a virtual contract manager (such as the apparatus defined in accordance with the second aspect of the present invention). By such registration, the virtual contracts can subscribe to events that affect its behaviour or output at any given time. As events are read or retrieved from the event queue, the virtual contract manager can use this registry as a guide to retrieving and reviving any persisted virtual contracts that have subscribed to this event.

In a preferred embodiment of the invention, it is the virtual contract manager which comprises the means for persisting virtual contract objects, preferably by taking them out of memory and storing them to a data structure on a local file system in a way that may be substantially perfectly restored even after an indefinite passage of time. The process of persisting a virtual contract includes storing (to a database or local file system) the current values of its state variables along with its rules for execution, and removing the object from memory. Restoring a particular virtual contract involves retrieving its state variables and execution rules from memory and restoring the object to its previous state, thus preparing the object to handle the event that triggered its restoration. This mechanism of persisting the virtual contract enables it to respond to an arbitrary set of events over an extremely broad range of time, from seconds to years.

In summary, the present invention can provide the core for licence repository and automated rights management services, making the task of rights decision-making easier and more efficient. The approach used to realise a preferred embodiment of the present invention involves providing a novel digital representation of a contract, the unique aspect of this model being that it is dynamic, in that it accurately captures the sequential characteristics of real contracts. Thus, the present invention provides means for explicitly capturing the full sequential, conditional flow of a contract, including specific outputs (rights and obligations) for states within the contract.

### BRIEF DESCRIPTION OF THE DRAWINGS

An embodiment of the present invention will now be described by way of example only and with reference to the accompanying drawings, in which:

### DETAILED DESCRIPTION OF THE INVENTION

The core of the following exemplary embodiment of the present invention is a generalised state machine “kernel” object that may be implemented as a software component in stand-alone applications, as a software component in internet-based electronic contract services, or as a the basis for information commerce systems that engage in rights transactions and information commerce.

Object-oriented programming or object programming is defined as any programming technique in which the primary components of the application program are objects. Objects are defined as instances of a class, and a class is defined as a collection of procedures called methods, and the data types they operate on.

In recent years, objects have been defined in terms of abstract data types, or ADT's, each of which consist of a data structure and the operation(s) used to access it, the data structure and operation being ‘encapsulated’. Encapsulation effectively results in ‘data hiding’ and is achieved in a variety of ways in different programming languages. However, in all cases, the concept of encapsulation or data hiding is used to prevent access to an object's state by other objects, except through the methods defined on the object. Methods and data are said to be visible when they can be accessed by other objects, and invisible or opaque when they cannot be directly accessed by any other object. The invisibility of an ADT's state and the separation of its interface part from its implementation part are what distinguishes an ADT from simple data types. It should be noted that the physical structure of a data type is even hidden from view by users of the type.

Thus, in a typical implementation of the present invention, multiple instances of the contract object, which will be referred to as “virtual contracts” for the remainder of the specification, can run concurrently and independently using ‘encapsulation’ as described above.

One of the most widely known object programming languages is C₊₊, and the present invention is preferably implemented in software based upon C₊₊ or any of a variety of other well-known object-oriented technologies, such as Java, Visual Basic, or object-oriented Perl.

The present invention is concerned with both the representation of dynamic contracts as state machines, and the mechanisms for executing those contracts over indefinite periods of time. The following steps generally set out the process of creating a dynamic contract representation, which steps can be performed manually or by means of one of a number of levels of automation:

If starting from a “legacy” (i.e. a pre-existing paper) contract, deconstruct the textual contract into its composite clauses;

For each clause of the contract, identify “inputs” and “outputs”. It should be noted that, in the case of a legacy contract, individual clauses may introduce a number of unique input/output combinations, each of which should be individually identified;

Encapsulate each unique input/output combination as a “state” of the contract;

For each state, identify internal (e.g. time) and external events that may trigger changes in output, and therefore transitions in state;

For each state, identify all possible state transitions (target states) and the conditions on trigger events that cause those transitions;

Encode all of this in a structured markup (e.g. in XML) that allows text-based rendering and functional interpretation. The resulting representation serves as the “source code” of the contract; it is an abstract model, but does not represent the actual state.

For the publishing contracts of particular interest in this description, the “outputs” in various states of a contract object will be assertions of contractual promises between parties, either rights being granted or transferred, or obligations being asserted. The specific expression of rights or obligations may be achieved using well-known vocabularies inherited from externally defined, authoritative “namespaces” (e.g. defined and administered by publishing consortia). In the case of rights, the emerging term of art for these vocabularies is “rights expression languages”.

The “source code” for the contract may be directly interpreted. However, more preferably, it may be compiled into an intermediate code representation that is appropriate for execution by a contract “virtual machine”, which option is considered to facilitate a more efficient persistence of active contract objects.

In all cases, contract objects are instantiated and managed through a Contract Manager (CM). Other services, such as digital rights management enforcement mechanisms, must query or send event notifications to specific contract instances by way of the CM. The CM may also query remote services as a way of monitoring event state. Upon creating an instance of a contract, the CM creates a cross-reference or registry of those events that it links or monitors on behalf of the contract objects it manages.

Once instantiated, a contract object (or “virtual contract”) which is not actively engaged (i.e. engaging in state transitions), will typically be persisted to local storage to await the ‘firing’ of a contract event. The persistence record should include a reference to the current state of the contract and the state machine intermediate code. The persistence mechanism may be achieved in many well-known ways, ranging from writing structured files (e.g. XML) to storing in a database.

When the Contract Manager detects an event that it has been monitoring, it re-constitutes the instance of the appropriate object from memory, sets the appropriate state and causes the state to transition as appropriate. Output signals as a result of the state transition are transmitted as appropriate. It should be noted that external enquiries to contract state will also cause contracts to be “thawed” from their persisted state.

A specific example of a typical agreement between an author and a publishing company will now be considered in more detail, and such an agreement is set out in printed, hardcopy form below.

The Publishing Company

Letter of Agreement

This letter is our agreement to publish your work:

(Which will be referred to in this letter as “the Work”), on the terms and conditions that follow:

Author's Grant

1. You hereby grant to the Publishing Company all right, title, and interest in the Work. This grant will include, without limitation, the entire copyright in the Work in all countries of the world for all terms of protection and with respect to all media now known or hereafter discovered.

Author's Warranty

2. You warrant:

(a) that you are the sole owner of the copyright in the Work;

(b) that the Work is original throughout;

(c) that your right to make the grant set out in Paragraph 1 is complete and unencumbered;

(d) that the Work has not been published before, and that no agreement for publication is outstanding;

(e) that no derivative works based upon the Work exist, and that no licenses with respect to the Work are outstanding;

(f) that as long as this contract is in force between us, you will not publish or cause to be published any work that is competitive with the Work, unless our written permission is first obtained (a work is “competitive” if it deals with substantially the same subject matter in the medium of print or a computer readable medium); and

(g) that the Work contains no scandalous, libelous, obscene, or otherwise unlawful matter, and that it does not invade the privacy or otherwise infringe upon the common-law or statutory rights of anyone;

(h) that the Work contains no instructions that, if carried out by the reader, would cause physical injury to any person. Warranties (a) through (g) do not apply to material of other authors for whose inclusion in the Work you have obtained valid permission.

Materials Created by Other Persons

3. In amplification of Paragraph 2, you agree that you will obtain, at your own expense, all necessary permissions, in writing, for any materials (such as illustrations, tables or extended abstracts) to be included in the Work for which the copyright is owned by someone else. Where instead materials you wish to include will be specifically created for the Work at your request, you will either commission those materials on a work-for-hire basis, so that they belong to you automatically and thus are subject to paragraph 1 of this Agreement, or you will secure a copyright transfer from the author to us, in either case using forms that we shall supply to you one request. *(see paragraph 29).

Indemnifications; Enforcement of Rights

4. If anyone brings any claim or action alleging facts that, if true, constitute a breach of any of the foregoing warranties, you will hold harmless and indemnify us, our grantees, our licensees, and our distributees against any liability, whether under judgement, decree or compromise, and any legal fees and expenses arising out of that claim or action, and you will cooperate fully in any defense we may make to such claim or action. Moreover, you will agree to cooperate in any claim or other action seeking to protect or enforce any right you have granted to us in the Work. If any such claim or action fails because of facts that constitute a breach of any of the foregoing warranties, you agree to reimburse whoever brings such claim or action for expenses and attorneys' fees incurred therein. This paragraph and the warranties in Paragraphs 2 and 3 will survive the termination of this agreement.

Delivery of the Work

5. You agree to deliver to us, in substance, content, form, and style satisfactory to us, on or before agreed delivery date

Two (2) clean and legible copies of the Work, including double spaced notes, tables, references, and captions; the originals of all documentation required under paragraph 3; and one set of illustrations ready for the printer, prepared according to the specifications that we shall supply.

You agree to retain one copy of these materials yourself. You also agree to submit with the copies of the Work an electronic version of the Work.

If in our judgement any of the materials that you deliver need to be retyped, redrawn or relettered, and if you choose not to do such work yourself, then we shall be free to have this work done by another, and you agree to reimburse us for this expense.

If you fail to make delivery by the date specified above, and unless within (60) days thereafter we consent in writing to postpone the delivery date, this contract will terminate. In such event, we shall grant back to you all the rights granted to us in Paragraph 1, on condition that you return to us all monies that may have been advanced or otherwise paid to you in connection with the Work. You agree, moreover, that you will not permit the Work to be published elsewhere without first having offered to reinstate this agreement on the same terms as contained herein. If we do not accept this offer within ninety (90) days of our receipt of it, then you will be free to publish the Work elsewhere.

Size of the Work

6. The work as delivered to us will consist of the following:

Agreement to Publish

7. As soon as practical after receipt of the final and complete version of the Work, and after its final approval by the Publishing Company, we shall publish the Work in the English language at our own cost and expense in such manner, style, and format and at such price as appears to us to be best suited for the sale of the Work.

Editing

8. Unless it has been agreed that the Work is to be printed directly from your submitted camera-ready copy, we shall edit the text to conform to the style that appears to us to be best suited to the Work. After it has been copy-edited, the typescript will be returned to for review. This will be your final opportunity to make changes in the Work.

Proof

9. You will be responsible for reading and correcting proof. When galleys or page proofs are submitted to you, you agree to correct typographer's errors and return proofs to us promptly. If you do not return corrected proofs to us within thirty (30) days after our mailing them to you, we shall be free to proceed with the manufacture and publication of the Work without waiting for your return of proofs. If for any reason you cannot read proofs, then we shall hire someone else to do so, and you agree to bear the expense of such proofreading.

Author's Alterations

10. The cost of author's alterations in proof (that is, changes other than corrections of typographer's errors and varying from the final copy-edited typescript) will be borne by us to the extent of 10 percent of the cost of the original composition but beyond that amount will be borne by you.

Index

11. We agree to prepare and pay for the index for the Work. The authors will supply a lis of key words to the indexer.

Basic Royalties

12. During the continuance of this agreement we shall pay you royalties computed as the following percentages of cash actually received by us on sales (less returns) of the Work as published by us:

(a) On sales of any hardbound edition through regular bookstore and wholesaler channels in the United States of America:

(b) On sales of any paperback edition through regular bookstore or wholesaler channels in the United States of America:

(c) On sales of any hardbound or paperback edition outside the continental United States of America:

(d) On sales directly to the consumer solicited by us through mail order, coupon advertising, or otherwise:

(e) On sales of overstock:

Royalty-Free Copies

13. We expect to distribute free copies of the Work for promotion, review, advertising, samples, and similar purposes; in such cases no royalties shall be payable on such copies.

Royalties from Other Sources

14. If we sell or license, whether exclusively or nonexclusively, all or any part of the right you have granted to us in the Work, we shall pay to you, at the time of the next royalty payment after receipt of any net proceeds of any such sale or license, the following percentages of those net proceeds (“net proceeds” means total cash receipts less all expenses incurred by us in connection with or pursuant to the sale or license):

(a) If the sale or license concerns the right to publish (that is, to reproduce and distribute) the Work or any portion thereof, whether by means of a bookclub, or in a periodical, or other compilation, or through a copublication agreement with another publisher, in a machine-readable medium (including transmission by wire or wireless or any other technology; or the right to make any derivative work other than a dramatisation or audiovisual adaptation:

(b) If the sale or license concerns the right to perform the work, or the right to dramatise or make audiovisual works based upon the Work:

Share of Damages

15. If we receive any sum under any judgement, decree, or compromise in the form of lost profits, profits of any infringer, or statutory damages, we shall pay you, at the time of the next royalty payment after receipt of such sum, 15 percent of the excess of the sum over whatever legal fees and expenses of ours are not separately reimbursed by an infringer. However, no payment will be due to you from us if you are separately compensated in your own right under the same judgement, decree, or compromise.

Royalty Statements

16. Royalty statements and payments will be made for each royalty year ending March 31, and will be mailed to you on or before the following June 30, except that, if the amount due to you is less than $25, no payment will be made until the first subsequent royalty year in which the total amount due reaches $25.

Author's Copies

17. We shall present copies of the Work to you upon publication. If you request additional copies for your own personal use, and not for resale, we shall supply them to you at a discount of 30 percent from the retail price.

Use of Author's Name

18. You grant permission for the use of your name, picture, and autobiographical data in connection with the distribution and publicising of the Work and the exercise of other rights you have granted to us.

Revisions

19. When requested by us in writing, you agree to revise the latest edition of the Work and to provide us with any new material necessary to keep the Work current and up to date. You agree that each provision of this agreement will govern any such revision or new material, wherever the context permits. If the Work is primarily a textbook and if for any reason you cannot or choose not to undertake such revision or preparation of new materials, you agree that we may engage some other person(s) for that purpose and deduct the cost thereof from royalties accruing to you on subsequent editions. If the material is prepared by others, that fact will be stated in the revised edition. You will, however, be given an opportunity to review all revisions and all new materials before publication.

Work Out of Print

20. If we should decide at any time after three years to terminate this agreement and discontinue publication of the Work, we shall advise you of this in writing. You will then have the right to require, by written notice, a return to you of all rights granted to us in this Work. You will at that time also be given the option to purchase, at 25 percent of actual cost, the negatives of the Work, should they exist, and to purchase at actual manufacturing cost (plus shipping) any copies and unbound sheets remaining in our hands. This option will remain open for thirty (30) days after the termination of this agreement; thereafter, we shall be free to dispose of any negatives, copies or sheets in any way we see fit, without payment of any royalties. (If, however, the means of dispositions is sale of stock to a wholesale remainder dealer, then paragraph 12e will apply.)

Validity of Licenses

21. If any right granted to us in Paragraph 1 is returned to you by operation of law or according to the terms of this agreement or otherwise, such right will remain subject to any license then in force, and we shall continue to collect and distribute all proceeds therefrom as if we remained the licensor.

Notices

22. Any notice pertaining to the substance of this agreement which either of us may wish to give to the other will be sufficient if hand-delivered or mailed by certified or registered mail to our respective addresses shown above, or as last appearing in our records, or to such other place as either of us may designate by written notice. Informal correspondence, statements, and remittances may be sent by ordinary mail.

Successors in Interest

23. This agreement will be binding upon, and will inure to the benefit of, our respective successors, licensees, and assignees, as well as your heirs, administrators or executors. However, during your lifetime, your interest in royalties hereunder may be assigned only as a whole, and at no time will any transfer of any of your rights hereunder be binding upon us until we have received due notice and evidence thereof in writing. No assignment may be made of any of your obligations under this agreement.

Force Majeure

24. We shall not be liable for delays caused by wars, civil riots, strikes, labour controversies, acts of God, governmental restrictions, or other circumstances beyond our control, nor shall the work be deemed out of print in the event of such delays.

Two or More Authors

25. In the event that there are two or more authors of the Work, all references in this agreement to “you” include both or all such authors jointly and severally, except that royalty and other payments will be divided as follows:

Governing Law

Amendments

27. This agreement contains the entire understanding between us. It may not be amended unless in writing signed by both of us. Its parts are separately enforceable and not mutually dependent.

Thus, it can be seen that an agreement or contract such as the one set out above, contains numerous clauses expressing promises between the parties to the agreement, with a variety of possible outcomes that are dependent upon the condition of other promises having been fulfilled or exercised. In the case of such a complex publishing contract, it can be difficult to manually evaluate the state of the contract at a given point in time and under a given set of conditions (including the contract's performance history).

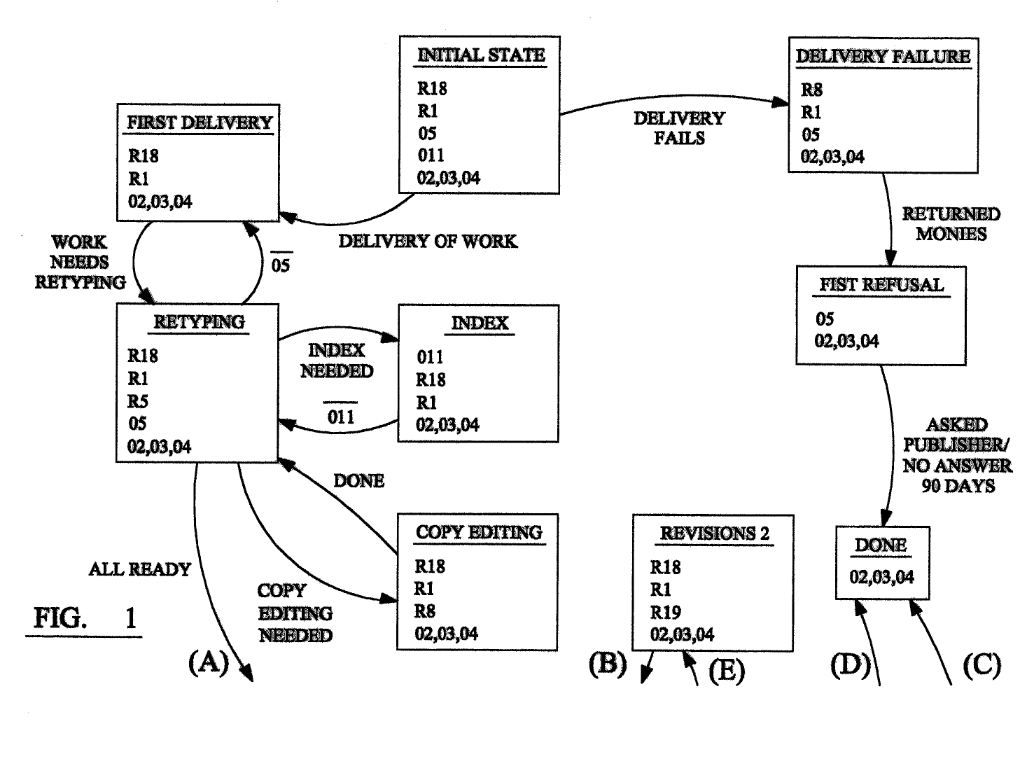

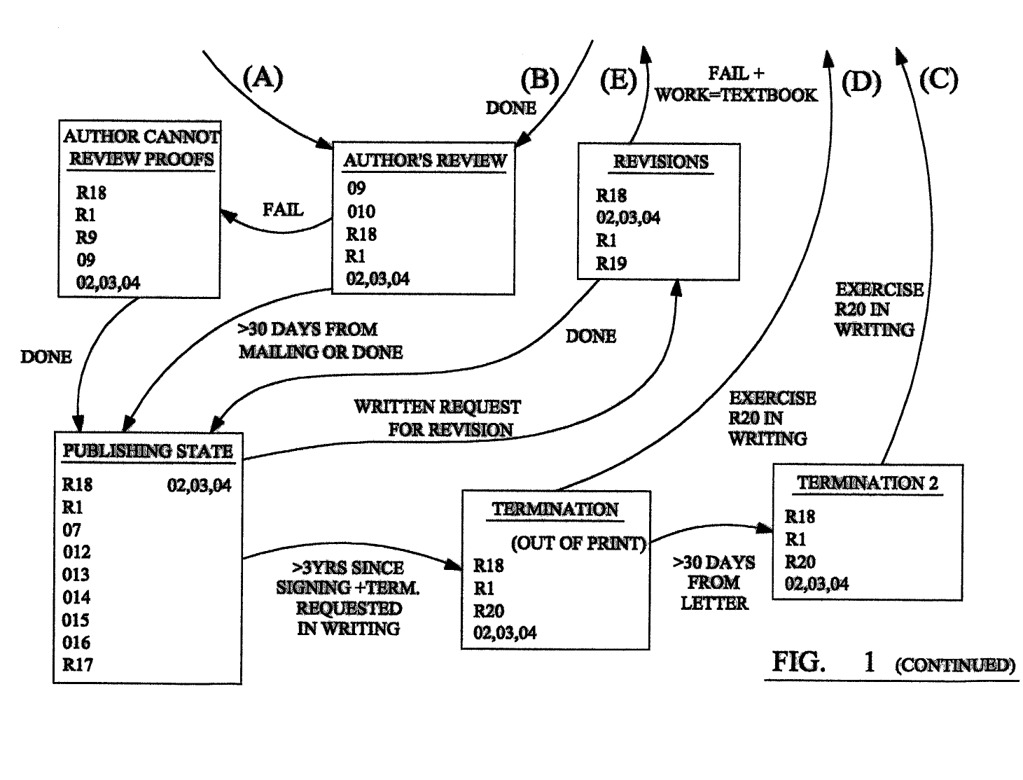

Referring to FIG. 1 of the drawings, there is illustrated a digital dynamic contract model of the legacy (“paper”) contract reproduced above, as defined by an aspect of the present invention. As shown, the contract is represented as a dynamic state machine “kernel” object, and the dynamic state machine behaviour (especially the state transitions within the contract model) is expressed in terms of the logical combination of events and conditions that may be in effect within a given state of the contract. The possible states of the contract model are represented in FIG. 1 as boxes, with each of the states being represented by a series of events and conditions which may be in effect when the contract is in a particular state.

When the contract model is in the ‘Initial State’ (i.e. when the agreement is first drawn up), as represented in FIG. 1 by the box having reference numeral 10, the author grants two sets of rights to the publishing company, namely the right to use the author's name, picture and autobiographical data (R18), and all right, title and interest in the Work (R1). In addition, the author is given a number of obligations, namely to deliver the work (O5), to deliver keywords for the index (O11), and the warranties set out in paragraphs 2, 3 and 4 of the paper contract reproduced above.

If the author meets his obligation to deliver the Work, the contract enters the ‘First Delivery State’, as represented by the box numbered 12. In this state, both sets of rights granted by the author to the publishing company are still in force, as are the warranties which the author is obliged to follow.

At this stage, the work might be deemed by the publishing company to require retyping, in which case, the contract will enter the ‘Retyping’ state 14, in which the publishing company's right to have the work retyped is in force, as is the author's obligation to deal with this requirement himself or bear the cost of having the work done by someone else (R5, O5). The contract model only enters the retyping state 14 if the Work is deemed to require retyping and, when such retyping has been completed (and the work paid for by the author, if necessary), the contract model returns to the ‘First Delivery’ state 12.

Similarly, the Work submitted by the author is likely to require copy-editing, for which the contract model enters the ‘Copy-editing’ state 16, in which the publishing company's right to copy-edit the Work is in force (R8), as is the author's right to review the copy-edited Work (R8). If an index is required to be prepared, the contract model enters the ‘Index’ state 18, in which the publishing company's obligation to prepare an index and pay for such preparation is in force, as is the author's obligation to provide the keywords for the index (O11). Once, the index has been prepared, the contract model returns to the ‘First Delivery’ state 12.

At this stage, the Work is required to be forwarded to the author for reading and correcting proof, and as such the contract enters the ‘Author's Review’ state 20, in which the author's obligation to review the proof (O9) and the obligations of both parties regarding the cost of changes to the proof (O10) are in force. If the author is unable to read proofs (provision for which is made in paragraph 9 of the paper contract reproduced above), the contract model enters the ‘Author Cannot Review Proofs’ state 24, in which the publishing company's right to hire someone else to read the proofs (R9) is in force, as is the author's obligation to bear the cost of this (O9).

When the proof has been reviewed, whether by the author or someone else, the contract model enters the ‘Publishing’ state 22. The contract may remain in the Publishing state for many years, and in this state, the publishing company's obligation to publish the Work at their own cost and expense (O7) is in force, as is their obligation to pay royalties as set out in the agreement (O12, 13, 14, 15, 16). Further, the author's right to receive from the publishing company copies of the Work upon publication thereof (R17), and the publishing company's obligation to supply further copies of the Work upon request at a discounted rate (O17) are also in force.

If required, the publishing company may invoke their right to request that the author revise the current edition of the Work (R119), in which case, the contract model enters the ‘Revisions’ state 34. In the ‘Revisions’ state 34, the author's obligation to revise the Work as requested is in force. However, if the Work is a textbook, and the author is unable or unwilling to revise it, the publishing company has the right to engage the services of someone else to effect the necessary revisions, and to revise future royalties accordingly (19). In this case, the author has the right to review all such revisions and the contract model returns to the ‘Author's Review’ 20 state. Whether the author carries out the requested revisions himself, or someone else is engaged to do so, once all obligations and rights at this stage have been disposed of, the contract model returns to the ‘Publishing’ state 22.

In the event that the publishing company decides to terminate the agreement and discontinue publication of the Work, the contract model enters the ‘Termination’ state 26, in which the author's right to request the return of the rights transferred to the publishing company is in force (R20), as is the author's right to purchase any remaining negatives, copies of the Work and unbound sheets at a discounted rate (R20). In the event that 30 days have elapsed since the termination of the agreement, without the author having exercised their right to purchase the remaining negatives, copies and unbound sheets, the contract model enters a ‘Disposal’ state 28, in which the publishing company's right to dispose of any such remaining negatives, copies and unbound sheets is in force.

Once the remaining negatives, copies and unbound sheets have either been purchased by the author or disposed of (or otherwise dealt with) by the publishing company, the contract model enters a ‘DONE’ state 30, in which the contract is terminated and all outstanding rights and obligations have been disposed of, except for the author's warranties set out in paragraphs 2, 3 and 4 of the paper contract reproduced above, which remain in force.

Of course, if the author fails to deliver the work as set out in paragraph 5 of the paper contract reproduced above, and the publishing company has not consented within 60 days after the agreed date of delivery to a postponement of the delivery date, the contract model enters a ‘Delivery Failure’ state 32, in which the publishing company's obligation to return the rights transferred to them by the author, subject to the return of any monies advanced or otherwise paid to the author in connection with the Work, is in force. Once these rights and obligations have been disposed of, the contract model enters a ‘First Refusal’ state 34 in which the author's obligation to offer to reinstate the agreement prior to allowing publication of the Work elsewhere is in force. The contract may remain in this state indefinitely (unless and until the author wishes to publish the Work elsewhere). The publishing company may accept the offer of reinstatement of the agreement, in which case the contract model returns to the ‘Initial’ state 10. If, however, the publishing company either refuse the offer or fail to reply to the offer within 90 days of receiving it, the contract model enters the ‘DONE’ state, in which only the warranties set out in paragraphs 2, 3 and 4 of the paper contract reproduced above.

A plurality of such contract models or objects can be instantiated and managed through a Contract Manager (CM). Other services, for example, digital rights enforcement mechanisms, must query or send event notifications to specific contract objects by way of the CM. The CM may also query remote services as a way of monitoring event state and ensuring that the current state of any one contract state machine is up-to-date and thus accurately reflects the current set of circumstances. Upon creating a contract object, the CM preferably creates a cross-reference or registry of those events that it monitors on behalf of the contract objects that it manages.

When the contract detects an event that it has been monitoring, it re-constitutes the instance of the appropriate object from memory, sets the appropriate state and causes the state of the contract to transition as appropriate. Output signals as a result of such a state transition are transmitted as appropriate.

In the foregoing specification, the invention has been described with reference to specific exemplary embodiments thereof. It will, however, be apparent to a person skilled in the art that various modifications and changes may be made thereto without departing from the broader spirit and scope of the invention as set forth in the appended claims. Accordingly, the specification and drawings are to be regarded in an illustrative, rather than a restrictive, sense.

1. Apparatus for determining the output of a contract or agreement at any point in time as required, comprising means for creating a state machine representative of said contract or agreement at least some of the clauses and/or conditions of said contract or agreement being represented as a respective state variable of said state machine, means for storing said state machine, means for receiving data representative of one or more events relevant to the contract or agreement, determining whether said event changes the status of said state machine and changing the status of said state machine if required.

2. Apparatus according to claim 1, comprising means for storing a plurality of state machines, each representative of a respective contract or agreement, the output of each said contract or agreement being determinable concurrently as required.

3. Apparatus according to claim 1, wherein the computer language used to realise the apparatus is an object-orientated computer language, such that the output of a contract state machine object are assertions that the object makes to other objects or systems.

4. Apparatus according to claim 1, including software components or systems which receive the output assertions of the virtual contract, and determine and implement the “wishes” or “intentions” of the contracts, as required.

5. Apparatus according to claim 1, comprising a kernel including means for storing a plurality of contract or agreements in the form of state machines, means for receiving information regarding events relevant to one or more of the contracts or agreements, and means for changing the state of one or more of the state machines as required according to said event.

6. Apparatus according to claim 5, comprising an event queue which accommodates “external” and “internal” events.

7. Apparatus according to claim 1, wherein if the state of a contract or agreement is not changed for a predetermined period of time, the contract is persisted to storage means to await the occurrence of one or more events which effect its behaviour or output.

8. Apparatus according to claim 1, wherein upon initialisation, virtual contracts are registered with a virtual contract manager such that they can subscribe to events that affect their behaviour to output at any given time.

9. A method of determining an output of a contract or agreement at any point in time as required, the method comprising the steps of creating a state machine representative of said contract or agreement, at least some of the clauses and/or conditions of said contract or agreement being represented by a respective state variable of said state machine, storing said state machine, receiving data representative of one or more events relevant to said contract or agreement, determining whether said event results in a change of state of said state machine and changing the status of said state machine accordingly, determining the state of said state machine at a point in time as required, and determining the output of said contract or agreement accordingly.

10. Apparatus for storing electronically a plurality of contracts or agreements each having a plurality of possible outputs dependent upon the occurrence (or otherwise) of one or more events, means for receiving the information relating to one or more events relevant to one or more of said contracts or agreements and means for determining the output of one or more of said contracts in response to the occurrence (or otherwise) of said one or more events.
